(19) United States
(12) Patent Application Publication
(10) Pub. No.: US 2007/0177251 A1
(43) Pub. Date: Aug. 2, 2007

(54) Optical device with polarization independent phase structure system

(75) Inventors: Bernardus Hendrikus Wilhelmus Hendriks, Eindhoven (NL); Emile Johannes Karel Verstegen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,555

(22) PCT Filed: Mar. 2, 2005
(86) PCT No.: PCT/IB05/50770

§ 371 Date: Sep. 5, 2006

(30) Foreign Application Priority Data
Mar. 9, 2004 (EP) 04300129.6

(51) Int. Cl. G02F 1/29

(52) U.S. Cl. 359/301

(57) ABSTRACT

The invention relates to an optical scanning device which comprises a phase structure system than can be used in various modes of operation of the optical scanning device. The optical device comprises a first phase structure (105) comprising a first birefringent material (203) having a first extraordinary axis and a second phase structure (106) comprising a second birefringent material (208) having a second extraordinary axis perpendicular to the first extraordinary axis. The first and second phase structures have substantially the same pattern. The optical device further comprises means (202, 205, 207, 210) for modifying the extraordinary refractive index of the first and the second birefringent material such that the extraordinary refractive indices of the first and the second birefringent materials remain substantially equal.

### FIELD OF THE INVENTION

The present invention relates to an optical scanning device comprising a phase structure intended to be used in various modes of operation of the optical scanning device.

The present invention is particularly relevant for an optical disc apparatus for recording to and reading from an optical disc, e.g. a CD, a DVD and/or a Blu-Ray Disc (BD) recorder and player.

### BACKGROUND OF THE INVENTION

Japanese patent application JP-A-2001209966 describes an optical scanning device that can operate in various modes of operation. In a first mode, the optical scanning device is intended to scan a first information carrier with a first radiation beam having a first wavelength. In a second mode, the optical scanning device is intended to scan a second information carrier with a second radiation beam having a second wavelength. In a third mode, the optical scanning device is intended to scan a third information carrier with a third radiation beam having a third wavelength. Spherical aberration is generated in this optical scanning device, due to the difference in cover layer thicknesses of the first, second and third information carriers. In order to compensate for the spherical aberration, a phase structure is used. Depending on the selected mode, the phase structure has to behave differently in order to generate different amounts of spherical aberration. To this end, the phase structure comprises a liquid crystal material which can be switched by application of an electric field, as a function of the selected mode. The design of the phase structure and the application of an electric field are chosen in such a way that the phase structure forms a diffracted radiation beam of the zeroth order for the first radiation beam and a diffracted radiation beam of a higher order for each of the second and third radiation beams.

Such an optical scanning device uses polarized light. To, this end, a polarizing beam splitter is placed between the radiation source that generates the radiation beam and the objective lens that focuses the radiation beam on the information carrier. As the phase structure generates spherical aberration, the amount of decentering between the phase structure and the objective lens that can be allowed is small. As a consequence, the phase structure has to be mounted on the actuator that moves the objective lens during tracking. This means that the phase structure has to be placed between the polarizing beam splitter and the objective lens, because the polarizing beam splitter is not mounted on the actuator. Now, a λ/4 wave plate is used in such an optical scanning device using polarized light. As the phase structure requires linear polarized light, it has to be placed before the λ/4 wave plate, i.e. the λ/4 wave plate has to be placed between the phase structure and the objective lens.

Due to this placement of the various optical elements in an optical scanning device such as described in JP-A-2001209966, the polarization of the radiation beam coming back from the information carrier towards the phase structure is orthogonal to the polarization of the radiation beam coming from the polarizing beam splitter towards the phase structure. This introduces artifacts in the detected radiation beam. For example, the second radiation beam, which is diffracted on the way towards the information carrier, because its polarization is such that the phase structure act as a diffractive grating for this polarization, will not be diffracted on the way back from the information carrier, because it has an orthogonal polarization for which the phase structure does not act as a diffractive grating anymore. This means that this second radiation beam follows a different optical path on the way towards and on the way back from the information carrier, which creates artifacts on the detector.

### SUMMARY OF THE INVENTION

It is an object of the invention to provide an optical scanning device comprising a phase structure that can be used in various modes of operation of the optical scanning device, wherein no artifact is created in the detected radiation beam.

To this end, the invention proposes an optical scanning device comprising a first phase structure comprising a first birefringent material having a first extraordinary axis and a second phase structure comprising a second birefringent material having a second extraordinary axis perpendicular to said first extraordinary axis, wherein the first and second phase structures have substantially the same pattern, the optical device comprising means for modifying the extraordinary refractive index of the first and the second birefringent material such that the extraordinary refractive indices of the first and the second birefringent materials remain substantially equal.

According to the invention, the optical scanning device comprises two phase structures comprising birefringent materials which extraordinary axes are perpendicular. As will be explained in the detailed description, such a combination of two phase structures is polarization independent. This means that the behaviour of the combination of these two phase structures does not depend on the polarization of the radiation beam that passes through said combination. As a consequence, no artifact is created in the detected radiation beam. For example, the second radiation beam of the prior art, which is diffracted on the way towards the information carrier, will also be diffracted on the way back from the information carrier, because the combination of the two phase structures will act as a diffractive grating, whatever the polarization of the radiation beam that passes through said combination. The second radiation beam will thus follow the same optical path on the way towards and on the way back from the information carrier.

The optical device in accordance with the invention comprises means for modifying the extraordinary refractive index of the first and the second birefringent material. This allows using the two phase structures in various modes of operation of the optical scanning device. When the mode of operation is changed, the extraordinary refractive index of the first and second birefringent materials is modified, in order, for example, to introduce a different amount of spherical aberration in the radiation beam. The modifying means are arranged such that the extraordinary refractive indices of the first and the second birefringent materials remain substantially equal. This ensures that the combination of the two phase structures in accordance with the invention is polarization independent.

Advantageously, the first and second birefringent materials are liquid crystal materials and the modifying means comprise means for applying an electric field to said liquid crystal materials. Such liquid crystal materials can easily be used as birefringent materials and can easily be treated so as to give them a desired extraordinary axis.

Preferably, the first and second phase structures form part of a same and one optical element. This makes the optical scanning device relatively compact.

The invention also relates to an optical element comprising a first phase structure comprising a first birefringent material having a first extraordinary axis and a second phase structure comprising a second birefringent material having a second extraordinary axis perpendicular to said first extraordinary axis, wherein the first and second phase structures have substantially the same pattern, the optical element comprising electrodes between which a potential difference can be applied so as to modify the extraordinary refractive indices of the first and the second birefringent materials.

These and other aspects of the invention will be apparent from and will be elucidated with reference to the embodiments described hereinafter.

### BRIEF DESCRIPTION OF THE DRAWINGS

The invention will now be described in more detail by way of example with reference to the accompanying drawings, in which:

FIG. 1 shows an optical scanning device in accordance with the invention;

FIG. 2 shows an optical element in accordance with the invention;

FIGS. 3a, 3b and 3c show the optical element of FIG. 2, in three modes of operation of the optical scanning device;

FIGS. 4a and 4b show another optical element in accordance with the invention in two modes of operation of the optical scanning device.

### DETAILED DESCRIPTION OF THE INVENTION

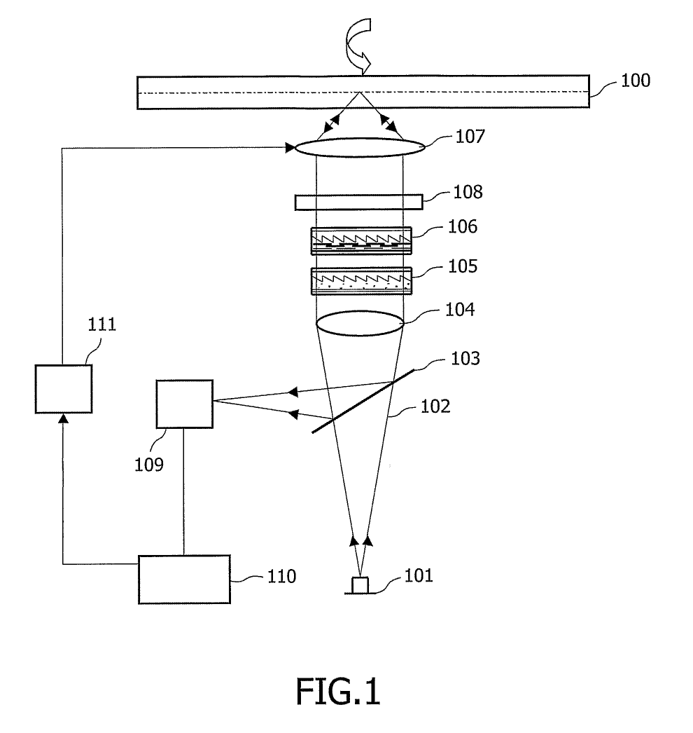

An optical scanning device in accordance with the invention is depicted in FIG. 1. This optical scanning device comprises a radiation source 101 for producing a radiation beam 102, a polarizing beam splitter 103, a collimator lens 104, a first phase structure 105, a second phase structure 106, an objective lens 107, a λ/4 wave plate 108, detecting means 109, measuring means 110, and a controller 111. This optical scanning device is intended for scanning an information carrier 100.

During a scanning operation, which may be a writing operation or a reading operation, the information carrier 100 is scanned by the radiation beam 102 produced by the radiation source 101. The collimator lens 103 and the objective lens 107 focus the radiation beam 102 on an information layer of the information carrier 100. A focus error signal may be detected, corresponding to an error of positioning of the radiation beam 102 on the information layer. This focus error signal may be used for correcting the axial position of the objective lens 107, so as to compensate for a focus error of the radiation beam 102. A signal is sent to the controller 111, which drives an actuator in order to move the objective lens 107 axially. The focus error signal and the data written on the information layer are detected by the detecting means 109.

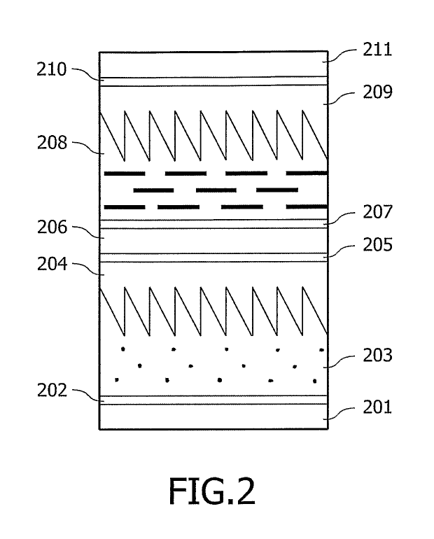

In the example of FIG. 1, the first and the second phase structure 105 and 106 are two different optical elements. The first and the second phase structure 105 and 106 may also form part of a same and one optical element, as depicted in FIG. 2. Moreover, at least one of the two phase structures 105 and 106 may be part of an optical element comprising other elements described in FIG. 1, such as the collimator lens 104 or the objective lens 107. The optical scanning device of FIG. 1 further comprises means for modifying the extraordinary refractive index of the first and second phase structures 105 and 106. This is detailed in the following Figs.

FIG. 2 shows in details the first and the second phase structure 105 and 106. In the example of FIG. 2, the first and the second phase structure 105 and 106 form part of a same and one optical element. This optical element comprises a first substrate 201, a first electrode 202, a first birefringent material 203, a first isotropic material 204, a second electrode 205, a second substrate 206, a third electrode 207, a second birefringent material 208, a second isotropic material 209, a fourth electrode 210 and a third substrate 211. The first birefringent material 203 and the first isotropic material 204 constitute the first phase structure 105. The limit between the first birefringent material 203 and the first isotropic material 204 form a first pattern. The second birefringent material 208 and the second isotropic material 209 constitute the second phase structure 106. The limit between the second birefringent material 208 and the second isotropic material 209 form a second pattern, which is substantially the same as the first pattern.

In the example of FIG. 2, the first and second birefringent materials 203 and 208 are liquid crystal materials. However, other birefringent materials may be used in accordance with the invention. For example, molecules comprising a charged substituent which can be rotated when subjected to a current created by a potential difference applied between two electrodes may be used. The second birefringent material 208 has an extraordinary axis which is perpendicular to the extraordinary axis of the first birefringent material 203. This may be achieved in that a suitable anisotropic network is used for the first and second birefringent materials 203 and 208.

Alternatively, a chemical or mechanical modification of the electrodes in contact with the birefringent materials may be performed, in order to induce a preferred orientation of the liquid crystal alignment.

Alternatively, additional alignment layers that enclose the birefringent materials may be used. Alignment layers may be used such as those typically used for the construction of conventional liquid crystal displays, such as rubbed polyimide alignment layers, or photoalignment layers, such as coumarin derivatives or cinnamate derivatives. Deposition of these alignment layers may be accomplished by conventional processing techniques, such as spin coating or dip coating. Depending on the type of alignment layer, subsequent rubbing is required or a brief UV-exposure, to induce the desired orientation. A benefit of the use of polyimides is their outstanding temperature stability, which is well above the typical degradation temperatures that are commonly observed for the majority of organic polymers.

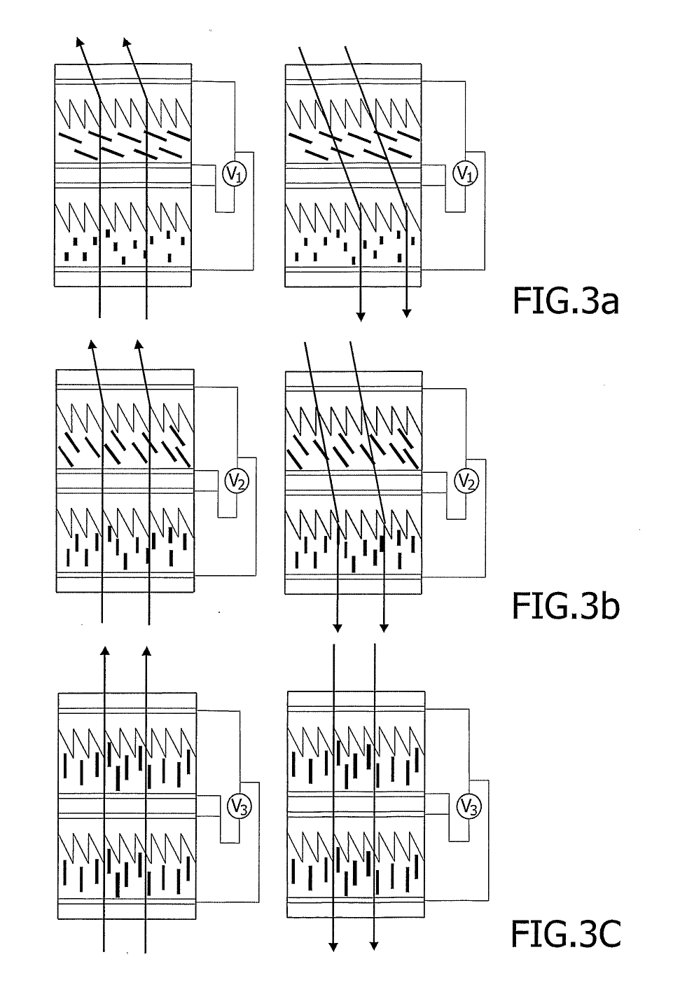

FIG. 2 shows the first and second phase structures 105 and 106 when no potential difference is applied between, on the one hand, the first and second electrodes 202 and 205 and, on the other hand, the third and fourth electrodes 207 and 210. Potential differences may be applied between these electrodes in order to create an electric field, as explained in FIGS. 3a, 3b and 3c. The first, second and third substrates 201, 206 and 211 are transparent, as well as the first, second, third and fourth electrodes 202, 205, 207 and 210.

In FIGS. 3a, 3b and 3c, the optical element of FIG. 2 is shown, in various modes of operation of the optical scanning device of FIG. 1. For reason of convenience, reference numbers are not shown in FIGS. 3a, 3b and 3c, but they are the same as the numbers in FIG. 2.

In FIG. 3a, a first potential difference V₁ is applied between, on the one hand, the first and second electrodes 202 and 205 and, on the other hand, the third and fourth electrodes 207 and 210. As a consequence, the same electric field is created in the first and second birefringent materials 203 and 208. The liquid crystal molecules of the first and second birefringent materials 203 and 208 accordingly rotate with a same angle. The liquid crystal molecules of the first birefringent material 203 rotate in a plane perpendicular to the sheet, whereas the liquid crystal molecules of the second birefringent material 208 rotate in the plane of the sheet. The extraordinary refractive indices of the first and second birefringent materials 203 and 208 thus remain equal. The extraordinary refractive index of a birefringent material varies between the nominal ordinary refractive index nₒ and the nominal extraordinary refractive index nₑ. When the molecules are oriented along the extraordinary axis, the extraordinary refractive index is nₑ. When the molecules are oriented perpendicular to the extraordinary axis, the extraordinary refractive index is nₒ. In the example of FIG. 3a, the extraordinary refractive index is between nₒ and nₑ, close to nₑ.

In this example, the isotropic material is chosen to have a refractive index equal to nₒ. FIG. 3a shows a radiation beam that passes through the optical element. In this example, the radiation beam has a polarization that is parallel to the extraordinary axis of the second birefringent material 208. As a consequence, the apparent refractive index of the first birefringent material 203 is nₒ for this radiation beam. As the isotropic material has a refractive index equal to nₒ, the first phase structure 105 acts as a transparent plate for this radiation beam, which means that the radiation beam is not diffracted. The apparent refractive index of the second birefringent material 208 is close to nₑ, between nₒ and nₑ. The second phase structure 106 accordingly acts as a diffractive grating, and the radiation beam is diffracted.

When returning from the information carrier, the radiation beam has a polarization that is perpendicular to its original polarization. In this example, the radiation beam has a polarization that is parallel to the extraordinary axis of the first birefringent material 203. As a consequence, the apparent refractive index of the second birefringent material 208 is nₒ for this radiation beam. The second phase structure 106 thus acts as a transparent plate for this radiation beam, which means that the radiation beam is not diffracted. The apparent refractive index of the first birefringent material 203 is close to nₑ, between nₒ and nₒ. The first phase structure 105 accordingly acts as a diffractive grating, and the radiation beam is diffracted. Because the extraordinary refractive index of the first and second birefringent materials 203 and 208 is the same, and the pattern of the first and second phase structures 105 and 106 is the same, the angle of diffraction is the same. If, as shown in FIG. 3a, the radiation beam that enters the optical element is a parallel beam, the optical beam that exits the optical element on the way back from the information carrier is also a parallel beam. As a consequence, no artifacts are created in the detected radiation beam.

It has been shown that this optical element, or this combination of two phase structures, is polarization independent. Whatever the polarization of the radiation beam that passes through said optical element, the optical element will behave in the same way. This has the further advantage that this combination of two phase structures can be placed anywhere on the optical path.

In FIG. 3b, a second potential difference V₂ is applied between, on the one hand, the first and second electrodes 202 and 205 and, on the other hand, the third and fourth electrodes 207 and 210. The second potential difference V₂ is such that the liquid crystal molecules rotate with a greater angle than in FIG. 3a. The extraordinary refractive index of the first and second birefringent materials is thus lower than in FIG. 3a.

In FIG. 3c, a third potential difference V₃ is applied between, on the one hand, the first and second electrodes 202 and 205 and, on the other hand, the third and fourth electrodes 207 and 210. The third potential difference V₃ is such that the liquid crystal molecules rotate with an angle of 90 degrees. As a consequence, the liquid crystal molecules are oriented perpendicular to the electrodes. This orientation is called homeotropic. In this situation, the optical element acts as a transparent plate. Actually, the apparent refractive index of the first and second birefringent materials 203 and 208 is no, whatever the polarization of the radiation beam.

The optical element shown in FIGS. 3a, 3b and 3c is used in three different modes of operation. As in JP-A-2001209966, the optical scanning device is intended to scan a first information carrier with a first radiation beam having a first wavelength in a first mode, a second information carrier with a second radiation beam having a second wavelength in a second mode and a third information carrier with a third radiation beam having a third wavelength in a third mode. In the following example, the first information carrier is a CD and the first radiation beam has a wavelength λ_{CD}=785 nm; the second information carrier is a DVD and the second radiation beam has a wavelength λ_{DVD}=650 nm; the third information carrier is a BD and the third radiation beam has a wavelength λ_{BD}=405 nm. The potential differences are chosen in such a way that the optical element forms a diffracted radiation beam of the zeroth order for the third radiation beam and a diffracted radiation beam of a higher order for each of the second and third radiation beams.

When the BD is scanned, the potential difference V₃ is applied, as shown in FIG. 3c. The third radiation is not diffracted, which means that a diffracted radiation beam of the zeroth order is formed. The potential differences V₁ and V₂ are chosen in such a way that for the first and the second radiation beam, a first order of diffraction is obtained. If n_{CD} is the extraordinary refractive index of the first and second birefringent materials 203 and 208 in FIG. 3a and n_{DVD} the extraordinary refractive index of the first and second birefringent materials 203 and 208 in FIG. 3b, it can be shown that a first order of diffraction is obtained for both CD and DVD when: n_{CD}=nₒ+(n_{DVD}−nₒ)λ_{CD}/λ_{DVD}

The potential differences V₁ and V₂ can easily be chosen in such a way that these extraordinary refractive indices are obtained. The combination of two phase structures in accordance with the invention thus can perform the same functions as the phase structure of the prior art, with the further advantage that it is polarization independent and thus does not create any artifact in the detected radiation beam.

Other orders of diffraction could be chosen, depending on the amount of spherical aberration to be compensated. For example, the potential differences can be chosen in such a way that the optical element forms a diffracted radiation beam of the zeroth order for the third radiation beam, a diffracted radiation beam of the first order for the second radiation beam and a diffracted radiation beam of the second order for the first radiation beam.

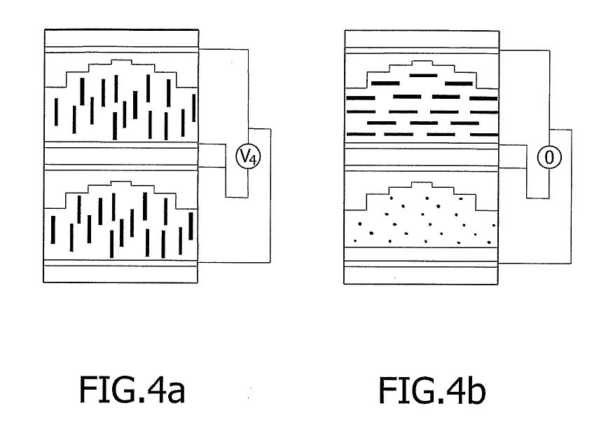

In FIGS. 4a and 4b, another optical element in accordance with the invention is depicted. This element corresponds to the optical element of FIG. 2, only the pattern being changed. For reason of convenience, reference numbers are not shown in FIGS. 4a and 4b, but they are the same as the numbers in FIG. 2. This optical element is used in an optical scanning device intended to scan an information carrier comprising two information layers. In such an optical scanning device, the objective lens is optimised for a first layer. When the second layer is scanned, spherical aberration is generated in the radiation beam, due to the spacer layer thickness between the two information layers. The pattern of the two phase structures of the optical element of FIGS. 4a and 4b is adapted for introducing a wavefront aberration in the radiation beam in order to compensate for the spherical aberration. Such a pattern is described in details in patent application WO 03/049095.

In FIG. 4a, a fourth potential difference V₄ is applied between, on the one hand, the first and second electrodes 202 and 205 and, on the other hand, the third and fourth electrodes 207 and 210. The fourth potential difference V₄ is such that the liquid crystal molecules are oriented perpendicular to the electrodes. In this situation, the optical element acts as a transparent plate, as described in FIG. 3c. This fourth potential difference V₄ is thus applied in a mode where the first information layer is scanned. In FIG. 4b, no potential difference is applied between the electrodes. When a radiation beam with a polarization parallel to the extraordinary axis of the second birefringent material 208 passes through this optical element, the first phase structure 105 acts as a transparent plate, whereas the second phase structure 106 introduces spherical aberration in the radiation beam. No potential difference is thus applied in a mode where the second information layer is scanned. If a radiation beam with a polarization parallel to the extraordinary axis of the first birefringent material 203 passes through this optical element, the first phase structure 105 introduces the same amount of spherical aberration in the radiation beam, whereas the second phase structure 106 acts as a transparent plate. This optical element is thus also polarization independent.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. An optical scanning device comprising a first phase structure (105) comprising a first birefringent material (203) having a first extraordinary axis and a second phase structure (106) comprising a second birefringent material (208) having a second extraordinary axis perpendicular to said first extraordinary axis, wherein the first and second phase structures have substantially the same pattern, the optical device comprising means (202, 205, 207, 210) for modifying the extraordinary refractive index of the first and the second birefringent material such that the extraordinary refractive indices of the first and the second birefringent material remain substantially equal.

2. An optical scanning device as claimed in claim 1, wherein the first and second birefringent materials are liquid crystal materials and the modifying means comprise means for applying an electric field to said liquid crystal materials.

3. An optical scanning device as claimed in claim 1, wherein the first and second phase structures form part of a same and one optical element.

4. An optical element comprising a first phase structure comprising a first birefringent material (203) having a first extraordinary axis and a second phase structure comprising a second birefringent material (208) having a second extraordinary axis perpendicular to said first extraordinary axis, wherein the first and second phase structures have substantially the same pattern, the optical element comprising electrodes (202, 205, 207, 210) between which a potential difference can be applied so as to modify the extraordinary refractive indices of the first and the second birefringent material.
